(19) United States
(12) Patent Application Publication
(10) Pub. No.: US 2020/0342640 A1
(43) Pub. Date: Oct. 29, 2020

(54) SYSTEM AND METHOD FOR BEAM HARDENING CORRECTION (BHC) IN COMPUTED TOMOGRAPHY (CT) IMAGE RECONSTRUCTION

(71) Applicants: University of Central Florida Research Foundation, Inc., Orlando, FL (US); iTomography Corporation, Barker, TX (US)

(72) Inventors: Alexander Katsevich, Oviedo, FL (US); Seongjin Yoon, Houston, TX (US); Michael Frenkel, Barker, TX (US)

(21) Appl. No.: 16/858,218

(22) Filed: Apr. 24, 2020

Related U.S. Application Data
(60) Provisional application No. 62/837,782, filed on Apr. 24, 2019.

(51) Int. Cl. G06T 11/00; G06T 7/00

(52) U.S. Cl. CPC G06T 11/006; G06T 11/005; G06T 2211/416; G06T 2211/421; G06T 7/0012

(57) ABSTRACT

An improved system and method for the reduction of beam hardening artifacts in CT image reconstruction based on polyenergetic x-ray projection data and polyenergetic x-ray calibration data from a known calibration phantom.

### CROSS-REFERENCE TO RELATED APPLICATIONS

This application claims priority to currently pending U.S. Provisional Patent Application No. 62/837,782 filed on Apr. 24, 2019 and entitled “System and Method for Beam Hardening Correction (BHC) in Computed Tomography (CT) Image Reconstruction, the entirety of which is incorporated herein by reference.

### BACKGROUND OF THE INVENTION

In Computed Tomography (CT) beam hardening effects result from the polychromatic nature of the x-ray beam and the energy dependence of the attenuation coefficient of the object being imaged, wherein x-rays of higher energy have a lower attenuation than x-rays of lower energy. Beam hardening results in undesirable artifacts in the reconstructed image.

Accordingly, what is needed in the art is an improved system and method for beam hardening artifact correction (BHC) in CT image reconstruction.

### SUMMARY OF THE INVENTION

In various embodiments, the present invention provides an improved system and method for beam hardening correction that reduces beam hardening artifacts in CT image reconstruction.

In one embodiment, the present invention provides a method for beam hardening correction (BHC) in image reconstruction from polyenergetic x-ray projection data. The method includes, acquiring polyenergetic x-ray calibration data from a calibration phantom having a known geometry and comprising at least a first material and a second material that is different than the first material, and acquiring polyenergetic x-ray projection data of an object of interest. The method further includes, performing beam hardening correction (BHC) and reconstructing a 3D image of the object from the polyenergetic x-ray projection data and the polyenergetic x-ray calibration data using an iterative image reconstruction algorithm, wherein the iterative image reconstruction algorithm comprises at least two applications of a non-iterative reconstruction step.

The method may further include, selecting a calibration constant for the iterative image reconstruction algorithm that ensures faster convergence of the iterative image reconstruction algorithm, wherein the calibration constant is reflective of a ratio of attenuations of the two materials comprising the calibration phantom. The method may additionally include, performing segmentation of the images reconstructed at the non-iterative reconstruction step.

The iterative BHC in image reconstruction algorithm may further include performing segmentation of images derived from images reconstructed at the non-iterative reconstruction step to generate a segmented second material image, forward projecting the segmented second material image to generate projection data and linearizing the projection data with respect to the first material for each x-ray beam, given an optical thickness of the second material for each x-ray beam.

Acquiring the polyenergetic x-ray projection data and the polyenergetic x-ray calibration further includes scanning the object of interest and scanning the calibration phantom. The scanning of the object of interest and the scanning of the calibration phantom are performed using the same spectral settings of the scanner but the scans may be performed at different times. Spectral conditions may include the x-ray source spectrum and filtration material and thickness.

The two materials of the calibration phantom may include a high-Z material and a low-Z material. In particular, one of the two materials may be a water-like material and the other of the two materials may be bone-like material. More specifically, one of the two materials may resemble an attenuation coefficient of water in the object of interest and the other of the two materials may be resemble an attenuation coefficient of bone in the object of interest.

In an additional embodiment, the present invention provides a system for beam hardening correction (BHC) in image reconstruction from polyenergetic x-ray projection data. The system includes, a memory for storing polyenergetic x-ray calibration data acquired from a scan of a calibration phantom having a known geometry and comprising at least two different materials and for storing polyenergetic x-ray projection data acquired from a scan of an object of interest and a data processor for performing BHC in image reconstruction from the polyenergetic x-ray projection data and the polyenergetic x-ray calibration data, wherein the data processor is adapted for performing operations to apply an iterative image reconstruction algorithm that comprises at least two applications of a non-iterative reconstruction step.

The data processor may further be adapted to select a calibration constant for the iterative image reconstruction algorithm that ensures faster convergence of the iterative image reconstruction algorithm, wherein the calibration constant is reflective of a ratio of attenuations of the two different materials comprising the calibration phantom. The data processor may additionally perform segmentation of the images reconstructed at the non-iterative reconstruction step.

In another embodiment, the present invention provides one or more non-transitory computer-readable media having computer-executable instructions for performing a method of running a software program on a computing device for performing beam hardening correction (BHC) in image reconstruction from polyenergetic x-ray projection data, the computing device operating under an operating system. The method includes issuing instructions from the software program for acquiring polyenergetic x-ray calibration data from a calibration phantom having a known geometry and comprising at least two different materials, acquiring polyenergetic x-ray projection data of an object of interest and performing beam hardening correction (BHC) and reconstructing a 3D image of the object from the polyenergetic x-ray projection data and the polyenergetic x-ray calibration data using an iterative image reconstruction algorithm, wherein the iterative image reconstruction algorithm comprises at least two applications of a non-iterative reconstruction step.

Accordingly, in various embodiments, the present invention provides an improved system and method for beam hardening artifact correction in CT image reconstruction.

### BRIEF DESCRIPTION OF THE FIGURES

FIG. 1 is a flow diagram illustrating a method for performing BHC in image reconstruction, in accordance with an embodiment of the present invention.

FIG. 2(a) illustrates a first test phantom used for the numerical experiments in various exemplary embodiments, in accordance with the present invention.

FIG. 2(b) illustrates a second test phantom used for the numerical experiments in various exemplary embodiments, in accordance with the present invention.

FIG. 3(a) shows the plot of ρ_{c} for Phantom 1 with noiseless data using a compressed gray scale, which is reconstructed from uncorrected data.

FIG. 3(b) shows the reconstructed ρ_{c} image for Phantom 1 with noiseless data after the 1^{st} iteration (water correction), in accordance with an embodiment of the present invention.

FIG. 3(c) shows the reconstructed ρ_{c} image for Phantom 1 with noiseless data after the 2^{nd} iteration, in accordance with an embodiment of the present invention.

FIG. 3(d) shows the reconstructed ρ_{c} image for Phantom 1 with noiseless data after the 3^{rd} iteration, in accordance with an embodiment of the present invention.

FIG. 4 shows exemplary profiles of CT reconstructed ρ_{c} of Phantom 1 with noiseless, uncorrected data. The vertical and horizontal lines in the image at the bottom left corner shows the location of corresponding profile with the similar orientation.

FIG. 5 shows exemplary profiles of CT reconstructed ρ_{c} of Phantom 1 with noiseless, uncorrected data after 1^{st} iteration (water correction). The vertical and horizontal lines in the image at the bottom left corner shows the location of corresponding profile with the similar orientation.

FIG. 6 shows exemplary profiles of CT reconstructed ρ_{c} of Phantom 1 with noiseless, uncorrected data after 2nd iteration. The vertical and horizontal lines in the image at the bottom left corner shows the location of corresponding profile with the similar orientation.

FIG. 7 shows exemplary profiles of CT reconstructed ρ_{c} of Phantom 1 with noiseless data after 3rd iteration. The vertical and horizontal lines in the image at the bottom left corner shows the location of corresponding profile with the similar orientation.

FIG. 8(a) shows the of ρ_{c} for Phantom 1 with noisy data using a compressed gray scale with uncorrected data.

FIG. 8(b) shows the reconstructed ρ_{c} image for Phantom 1 with noisy data after the 1^{st} iteration (water correction), in accordance with an embodiment of the present invention.

FIG. 8(c) shows the reconstructed ρ_{c} image for Phantom 1 with noisy data after the 2^{nd} iteration, in accordance with an embodiment of the present invention.

FIG. 8(d) shows the reconstructed ρ_{c} image for Phantom 1 with noisy data after the 3^{rd} iteration, in accordance with an embodiment of the present invention.

FIG. 9 shows exemplary profiles of CT reconstructed ρ_{c} of Phantom 1 with noisy, uncorrected data. The vertical and horizontal lines in the image at the bottom left corner shows the location of corresponding profile with the similar orientation.

FIG. 10 shows exemplary profiles of CT reconstructed ρ_{c} of Phantom 1 with noisy data after 1^{st} iteration (water correction). The vertical and horizontal lines in the image at the bottom left corner shows the location of corresponding profile with the similar orientation.

FIG. 11 shows exemplary profiles of CT reconstructed ρ_{c} of Phantom 1 with noisy data after 2nd iteration. The vertical and horizontal lines in the image at the bottom left corner shows the location of corresponding profile with the similar orientation.

FIG. 12 shows exemplary profiles of CT reconstructed ρ_{c} of Phantom 1 with noisy, uncorrected data after 3rd iteration. The vertical and horizontal lines in the image at the bottom left corner shows the location of corresponding profile with the similar orientation.

FIG. 13(a) shows reconstructed ρ_{c} images of Phantom 1 with noiseless data after 4 iterations, in accordance with an embodiment of the present invention.

FIG. 13(b) shows reconstructed ρ_{c} images of Phantom 2 with noiseless data after 4 iterations, in accordance with an embodiment of the present invention.

FIG. 13(c) shows the absolute difference between the images in FIG. 13(a) and FIG. 13(b), in accordance with an embodiment of the present invention.

### DETAILED DESCRIPTION OF THE INVENTION

Various methods for beam hardening correction (BHC) of CT projection data are known in the art, including, iterative, non-iterative and hybrid methods. However, most currently employed methods for BHC of CT projection data do not utilize measured scanner spectral/multi-energy calibration information for the reconstruction of the image. Most of the work in the field is directed towards estimating the calibration data by other means. The most straightforward approach, when calibration information is available, is to use an iterative method to perform BHC. This approach is capable of achieving a desired BHC accuracy, but it is slow.

The present invention provides a system and method for collecting polyenergetic x-ray projection data of an object of interest by a scanner and reconstructing a 3D image of the object from the polyenergetic x-ray projection data using an efficient iterative image reconstruction algorithm and a calibration phantom of known geometry which consists of water-like and bone-like materials that resemble the attenuation coefficients of water and bone in the object of interest.

Throughout the detailed description of the invention, the following notations will be used:

D(E) detector response

S(E) source spectrum

I(E) normalized spectrum

T_{w} line integral of parameters for water-like materials along the beam path

T_{b} line integral of parameters for bone-like materials along the beam path

μ_{w} attenuation coefficient of water-like material in the calibration phantom

μ_{b} attenuation coefficient of bone-like material in the calibration phantom

c₀ is some scaling constant.

ρ_{w}(x) water image reconstructed from the values of T_{w}

ρ_{b}(x) denote bone image reconstructed from the values of T_{b}

In the following detailed description, it is assumed that the two base materials of the calibration phantom are water-like and bone-like materials. However, this assumption is only intended to simplify the description. For example, a first base material of the calibration phantom may be a high-Z material and the second base material of the calibration phantom may be a low-Z material. For example, the base material pair may consist of titanium (high-Z) and teflon (low-Z), wherein Z is the atomic number of the material itself. In determining the calibration phantom, two disks, one of water like material and the other of bone like material, are selected and placed anywhere in the field of view of the scanner. It is not required that the two disks be in contact with each other. The only requirement is that along their diameter each disk has to provide the corresponding maximum attenuation (T_{w}^{max} and T_{b}^{max}).

From geometry it is easy to prove that there is a line through the two disks that provides any given pair of attenuations (T_{w},T_{b}) within the respective maxima.

In various embodiments the present invention provides an improved beam-hardening correction algorithm, wherein:

F(T_{w},T_{b})=−ln(f_{E}_{ₘᵢₙ}^{E}^{ₘₐₓ}I(E)e^{-(f}^{_{w}}^{(E)T}^{_{w}}^{+f}^{_{b}}^{(E)T}^{_{b}}⁾dE), (1.1)

\hat{F}(T_{c},T_{b})=−ln(f_{E}_{ₘᵢₙ}^{E}^{ₘₐₓ}I(E)e^{-(f}^{_{w}}^{(E)T}^{_{w}}^{+f}^{_{b}}^{(E)T}^{_{b}}⁾dE),

T_{c}=T_{w}+T_{b}.

Since \hat{F}(p,q)=F(p−q,q), the function \hat{F} can be computed if F is available. To find F, a calibration phantom is used with known geometry, which consists of water-like and bone-like materials that resemble the attenuation coefficients of water and bone, respectively.

Let:

f_{w}(E):=μ_{w}(E),f_{b}(E):=μ_{b}(E)/c₀. (1.2)

where μ_{w} and μ_{b} are the attenuation coefficients of water-like and bone-like materials in the calibration phantom, respectively, and c₀ is some scaling constant. Let ρ_{w}(x) and ρ_{b}(x) denote water and bone images, respectively, that are reconstructed from the values of T_{w} and T_{b}. With the above choice of f_{w}, f_{b}, the actual attenuation coefficient of the object is given by:

μ(x,E)=ρ_{w}(x)μ_{w}(E)+ρ_{b}(x)μ_{b}(E)/c₀ (1.3)

It is emphasized that the reconstructed ρ_{w}(x) is the ratio of the density of water-like material in the object divided by the density of the water-like material in the calibration phantom. This follows from using μ_{w}(E), which is the attenuation coefficient of the water-like material in the calibration phantom. Likewise, ρ_{b}(x) is the ratio of the density of the bone-like material in the object divided by the density of the bone-like material in the calibration phantom and, additionally, multiplied by the normalization constant c₀.

The sum ρ_{c}(x)=ρ_{w}(x)+ρ_{b}(x) is referred to as the complete image. The complete image ρ_{c} corresponds to the reconstruction from T_{c}. The construction of the present invention guarantees that ρ_{c}=1 for the water-like material, and ρ_{c}=c₀ for the bone-like material.

The constant c₀ plays two roles in the reconstruction. The first role of c₀ is to help distinguish bone from water in the CT image reconstructed from T_{c}. In particular it can be seen that c₀ should be greater than 1 to separate bone-range values of ρ_{c} from water-range values of ρ_{c} by segmentation.

The second role of c₀ is to ensure the fastest convergence of the method. The following description details an iterative method with the first reconstruction from water-corrected data. Considering that any c₀>0 can be chosen, and the average value of reconstructed bone voxels will be close to c₀ upon convergence, c₀ should be as close as possible to that obtained by the first reconstruction, which will result in faster convergence of the iterations.

To better understand the second role of c₀, first consider:

$$\overline{{f}_{w}} : = {\int }_{{E}_{min}}^{{E}_{max}} I ( E ) {f}_{w} ( E ) d E = \frac{\partial }{\partial {T}_{w}} F ( {T}_{w} , {T}_{b} ) {\vert}_{{T}_{w} = {T}_{b} = 0} , \\ \overline{{f}_{b}} : = {\int }_{{E}_{min}}^{{E}_{max}} I ( E ) {f}_{b} ( E ) d E = \frac{\partial }{\partial {T}_{b}} F ( {T}_{w} , {T}_{b} ) {\vert}_{{T}_{w} = {T}_{b} = 0} . \qquad ( 1.4 )$$

The quantities f̅_{w} and f̅_{b} can be considered as weighted averages of f_{w}(E) and f_{b}(E), respectively. It follows that c₀ has the effect of scaling the T_{b} image. As such, it is clear that the parameter T_{b} can always be scaled by finding c₀ so that:

f̅_{w}=f̅_{b} (1.5)

The following definitions are introduced:
The water-equivalent thickness is the sinogram data linearized by the water-correction method, and
The water-equivalent density is the image values reconstructed from the water-equivalent thickness data.

Note that the first pass reconstructed value is by definition the water-equivalent density. In physical interpretation, c₀ that satisfies (1.5) is the water-equivalent density of the bone when the thickness of the object is infinitesimally small.

To see this, notice that for a weakly attenuating object, the attenuation data is given by:

$$F \approx ( \int I ( E ) {μ}_{w} ( E ) d E ) {ρ}_{w} {δ}_{w} + \frac{( \int I ( E ) {μ}_{b} ( E ) dE )}{{c}_{0}} {ρ}_{b} {δ}_{b} . \qquad ( 1.6 )$$

Here δ_{w,b} are thicknesses of water- and bone-line materials, respectively, along any pencil beam and ρ_{w,b} are their normalized densities as defined above. Suppose that the object is purely bone-like, then:

$$F \approx \frac{( \int I ( E ) {μ}_{w} ( E ) dE )}{{c}_{0}} {ρ}_{b} {δ}_{b} . \qquad ( 1.7 )$$

One would like to find the density of a water-like object ρ_{w} of the same thickness δ_{b} such that is provides the same attenuation. Hence:

$$F \approx \frac{( \int I ( E ) {μ}_{b} ( E ) dE )}{{c}_{0}} {ρ}_{b} {δ}_{b} = ( \int I ( E ) {μ}_{w} ( E ) d E ) {\hat{ρ}}_{w} {δ}_{b} . \qquad ( 1.8 )$$

From (1.2), (1.4), and (1.5), one gets:

$${c}_{0} = \frac{\int I ( E ) {μ}_{b} ( E ) dE}{\int I ( E ) {μ}_{w} ( E ) dE} . \qquad ( 1.9 )$$

Hence, from (1.6) and (1.9), \hat{ρ}_{w}=ρ_{b}. In particular, if the bone-like material in the object is the same as in the calibration phantom, then ρ_{b}=c₀, and one gets that its water-equivalent density is \hat{ρ}_{w}=c₀. Using linearity of the data (1.6), this means that if there is a weakly attenuating object made of the same bone-like material as the phantom and of water-like materials, then the first-pass reconstruction from water-corrected data will produce an accurate reconstruction, and the bone-like voxels will have reconstructed density c₀. Hence, the choice of c₀ based on (1.4) and (1.5) will help iterations converge faster for small weakly attenuating objects.

While c₀ obtained by (1.4) and (1.5) is a good approximation for the water-equivalent density of bone when the object is small, c₀ deviates further from the water-equivalent density of bone as the object becomes bigger. Thus, one can generalize (1.4) to account for larger objects as follows:

$${\overline{f}}_{w} ( {\overline{T}}_{w} ) : = \frac{\partial }{\partial {T}_{w}} F ( {T}_{w} , {T}_{b} ) {\vert}_{{T}_{w} = {\overline{T}}_{w} , {T}_{b} = 0} , \\ \overline{{f}_{b}} ( {\overline{T}}_{w} ) : = \frac{\partial }{\partial {T}_{b}} F ( {T}_{w} , {T}_{b} ) {\vert}_{{T}_{w} = {\overline{T}}_{w} , {T}_{b} = 0} , \qquad ( 1.10 )$$

where T̅_{w} is some average water-equivalent thickness. Therefore, c₀ can be found that satisfies the following modified version of (1.5):

f̅_{w}(T̅_{w})=f̅_{b}(T̅_{w}) (1.11)

Similar to the case of (1.5), the physical interpretation of c₀ that satisfies (1.11) is the exact water-equivalent density of a small weakly attenuating piece of bone-like material located at the center of the circular water object with diameter T_{w}. Indeed, similarly to (1.8), one has:

$$\frac{\partial }{\partial {T}_{w}} F ( {T}_{W} , {T}_{b} ) {\vert}_{{T}_{w} = {\overline{T}}_{w} , {T}_{b} = 0} {\hat{T}}_{w} = \frac{\partial }{\partial {T}_{b}} F ( {T}_{W} , {T}_{b} ) {\vert}_{{T}_{w} = {\overline{T}}_{w} , {T}_{b} = 0} {T}_{b} . \\ \qquad ( 1.12 )$$

Here, T_{b}=ρ_{b}δ_{b} is the optical thickness of bone, and \hat{T}_{w}=\hat{ρ}_{w}δ_{w} is the equivalent additional optical thickness of water. Requiring δ_{b}=δ_{w} and using (1.11) gives, as before \hat{ρ}_{w}=ρ_{b}. For pencil beams that do not go through the center of the disk, water-based correction is exact. The above derivation shows that the water-based correction for pencil beams through the center is exact as well, since the optical thickness of water is precisely T̅_{w}. Hence, the reconstruction will be exact and produce the value of c₀ if the bone-like material is the same as in the phantom.

For an object of arbitrary shape, where bones are neither small nor at the center, one cannot set c₀ exactly the same as the water-equivalent density of bone since the water-equivalent density is not constant. In this case, the water-equivalent density of bone depends on water and bone thicknesses, which are unknown and change from one ray to the other. Hence, the best one can do is find c₀ using some averaged water-equivalent thickness using the assumption that the energy dependence of the attenuation coefficient of bone is not too much different from that of water (or, equivalently, that the amount of bone is small).

The value of c₀ is needed for bone correction. Thus, it is logical to evaluate c₀ using pencil beams through the areas where bones are concentrated. Let T_{w}⁽¹⁾ denote the water-equivalent thickness data based on a water-correction method. One can assume that most of the rays that pass through bones will have a large value of T_{w}⁽¹⁾. Hence, one can collect the maximum value of T_{w}⁽¹⁾ for each view, and then define T̅_{w} as the averaged value of these collected view-wise maxima.

The process of computing c₀ using T̅_{w} is based on a number of approximations. There can be a case when there is no bone along the ray that produces the maximum T_{w}⁽¹⁾ for each view. Fortunately, the semi-iterative scheme that is proposed, and that will subsequently be described, is not very sensitive to the value of c₀, and the values of f̅_{w}(T̅_{w}) and f_{b}(T_{w}) depend fairly weakly on T̅_{w}, except when T̅_{w} is extremely small. Thus, any c₀ with a reasonably approximated T̅_{w} enables the algorithm to converge in a few iterations.

Another way to define c₀ is by applying empirical segmentation to the first pass reconstruction (water-equivalent density) image to find the bone region, and then average the water-equivalent density values of bones. In most cases, the water-equivalent density of the majority of water-like materials is well below that of bone-like materials. Therefore, one can easily identify bone-like materials from the first pass reconstructed image using the prior knowledge of the range of bone-like materials. Note that the range of the water-equivalent density of bone-like materials depends on the specific scanner setting and thickness of the object. Equations (1.10) and (1.11) can be used to find the approximated extrema of the water-equivalent density of the bone for the specific scanner setting. One may use both methods for evaluating c₀, and compare the results to ensure the stability of finding c₀.

Once the normalization parameter c₀ is set, the idea of a semi-iterative reconstruction algorithm is as follows. Let ρ_{c}^{(ex)} be the exact (actual) complete image. Consider the diagram:

$${ρ}_{c}^{( ex )} {}^{{bone}_{segmentation}} {ρ}_{b}^{( ex )} {}^{{forward}_{projection}} {T}_{b} {}^{{solving}_{\hat{F} ( {T}_{c} , {T}_{b} ) = d for {T}_{c}}} {T}_{c} {}^{FDK} {ρ}_{c}^{( ex )} . \qquad ( 1.13 )$$

In other words, following the sequence of the above steps, one arrives back at the original exact image ρ_{c}^{(ex)} Introduce the following notations:
1) [symbol] _{b} denotes the operation that segments out the bone image from ρ_{c}:ρ_{b}= [symbol] _{b}(ρ_{c});
2) [symbol] denotes forward projection: T_{b}= [symbol] (ρ_{b});
3) F_{c}=\hat{F}⁻¹(d,T_{b}) denotes solving \hat{F}(T_{c},T_{b})=d for T_{c};
4) [symbol] denotes application of FDK (Feldkamp, Davis, and Kress) or any other known inversion algorithm to linearized data: ρ= [symbol] T.

In terms of the above notations, the diagram in (1.13) can be written as follows:

ρ_{c}^{(ex)}= [symbol] (\hat{F}⁻¹(d, [symbol] ( [symbol] _{b}ρ_{c}^{(ex)}))). (1.14)

Therefore, one can propose a reconstruction algorithm using the following fixed point iterative scheme:

ρ_{c}^{(k+1)}=(1−α)ρ_{c}^{(k)}+α [symbol] (\hat{F}⁻¹(d, [symbol] ( [symbol] _{b}ρ_{c}^{(k)}))),k=0,1,2, . . . (1.15)

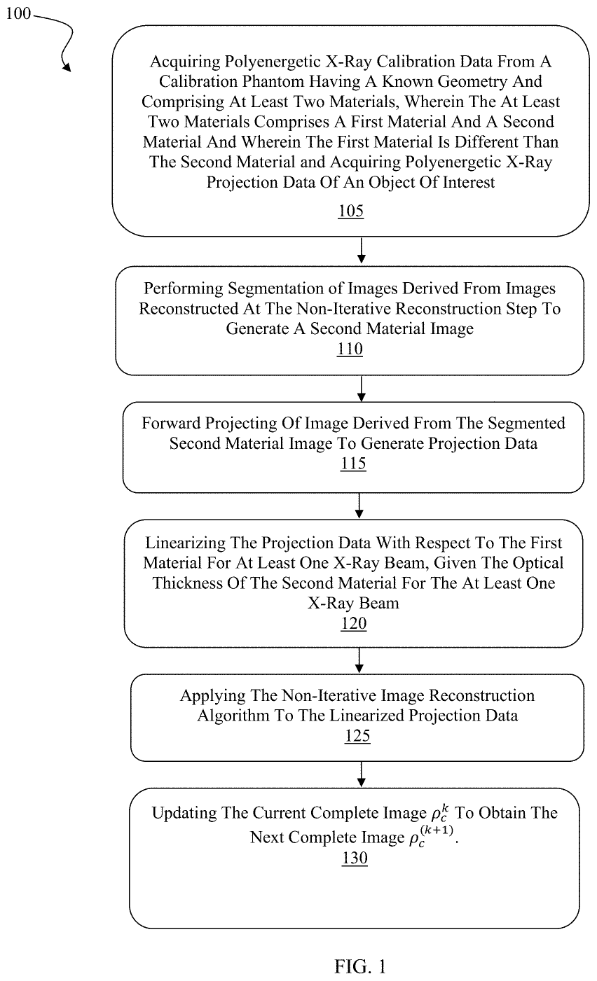

The flow diagram 100 of FIG. 1 illustrates the method of the present invention for performing an iterative scheme to reconstruct an exact image ρ_{c}^{(ex)}. At a first step 105, polyenergetic x-ray calibration data from a calibration phantom having a known geometry and comprising at least a first material and a second material that is different than the first material is acquired and polyenergetic x-ray projection data of an object of interest is acquired. At step 110, segmentation is performed of images derived from images reconstructed at the non-iterative reconstruction step to generate a second material image. As such, the second material image is segmented out of the current complete image ρ_{c}^{(k)}. Step 110 is represented by the symbols [symbol] _{b}ρ_{c}^{(k)} in (1.15). In step 115, the image derived from the segmented second image from step 110 is forward projected to generate projection data. Step 115 is represented by the symbols [symbol] ( [symbol] _{b}ρ_{c}^{(k)}) in (1.15). In step 120, the projection data is linearized with respect to the first material for each x-ray beam, given the optical thickness of the second material for each x-ray beam. Step 120 is represented by the symbols (\hat{F}⁻¹(d, [symbol] ( [symbol] _{b}ρ_{c}^{(k)})) in (1.15). One can view this step as data linearization with respect to water, which is the first material in this case, because the line integral T_{c} of the complete image ρ_{c} is multiplied by the attenuation coefficient of water f_{w}(E) in the second equation in (1.1). In step 125, a non-iterative image reconstruction algorithm is applied to the linearized projection data. Step 125 is represented by the symbols [symbol] (\hat{F}⁻¹(d, [symbol] ( [symbol] _{b}ρ_{c}^{(k)}))) in (1.15). In the final step 130 the current complete image ρ_{c}^{(k)} is updated to obtain the next complete image ρ_{c}^{(k+1)}. Additionally, the above procedure may include performing auxiliary substeps between the main steps, e.g. denoising.

In general, the relaxation parameter α>0, should be sufficiently small to guarantee convergence. However, no unstable behavior has been observed during experiments, so α=1 is considered reasonable. Also, it has been found that filtering to stabilize the iteration, as has been previously suggested by others, is not required within a reasonable noise intensity, seemingly due to the accurate implementation of the forward- and back-projection of the present invention.

By comparing (1.15) and (1.14), one can see that when the algorithm converges, under the ideal circumstances such as noise free precise data, etc., it is expected to converge to the exact solution. Thus, by applying the iterative algorithm in (1.15), a sufficient number of times, the computed solution can approach the exact solution as closely as desired, thereby providing a theoretically exact solution.

The iterations begin using the assumption that the very first bone image is zero: [symbol] _{b}ρ_{c}⁽⁰⁾=0. Consequently, ρ_{c}⁽¹⁾ becomes the water-corrected CT image, as previously described. Equation (1.15) shows that the invented algorithm is of the hybrid type, wherein if the initial approximation is already fairly accurate, one needs only a limited number of iteration. The expectation is that since one uses an accurate inversion algorithm for backprojection, one will achieve convergence much faster than with a more conventional, full-blown iterative algorithm approach.

Once c₀ is set, the following soft-thresholding segmentation is applied to identify the bone image at each iteration step to account for the partial volume effect:

$${b}_{} {ρ}_{c} = \{ \begin{matrix}0 , & if {ρ}_{c} < 1 \\ {c}_{0} \frac{{ρ}_{c} - 1}{{c}_{0} - 1} , & if 1 \leq {ρ}_{c} < {c}_{0} \\ {ρ}_{c} , & if {ρ}_{c} \geq {c}_{0}\end{matrix} \qquad ( 1.16 )$$

This soft-thresholding segmentation helps to find the solution, especially when c₀ is far away from the initial water-equivalent density, by gradually adjusting the ratio between bone and water in each pixel.

Note that in (1.16), it is assumed that the sum of volume fractions of water and bone always equals one whenever a mixture of bone and water is present in a voxel. This required is known as the volume conservation assumption and it may not always hold in practice. However, one can modify the transition curve in (1.16) based on experiments or on prior knowledge of water-bone composition. The effect of model error in the soft-thresholding segmentation is discussed in greater detail below, based on simulated examples.

The assumption of the proposed invented method is that the bone image obtained by the first pass reconstruction and segmentation is reasonably close to the true bone image, which should guarantee quick convergence. This assumption holds if the amount of bone is not too significant or, if the energy dependence of the attenuation coefficient of bone is not too much different from that of water. The latter condition means that f_{b}(E) and f_{w}(E) are not too different within the relevant energy range. Note that the proposed scaling helps to increase the accuracy of this approximation as much as possible by re-scaling the functions f_{w} and f_{b} to ensure that their weighted average values are equal, as shown in (1.11).

An exemplary embodiment is described to verify the performance of the proposed BHC method, and to compare it with the water-correction method known in the art.

In the exemplary embodiment, it is assumed that source-to-ISO and ISO-to-detector distances are 30.66 and 25.47 cm, respectively, and the detector has a single row of 2,048 pixels with pitch 0.15 mm Here “ISO” stands for the center of rotation.

For noise application, it is assumed that the source is 50 keV, 1 mA, and is prefiltered by a 0.5 mm aluminum. Exposure time is set to 0.2 second per view, and total of 1,440 view with 0.25 degree interval are used. The sensitive area of each detector pixel is set to 0.145×0.145 mm². Detector type is CsI(TI) scintillator with 5% Thallium in volume. The scintillator is assumed to convert all absorbed photo energy to electrical signals without loss.

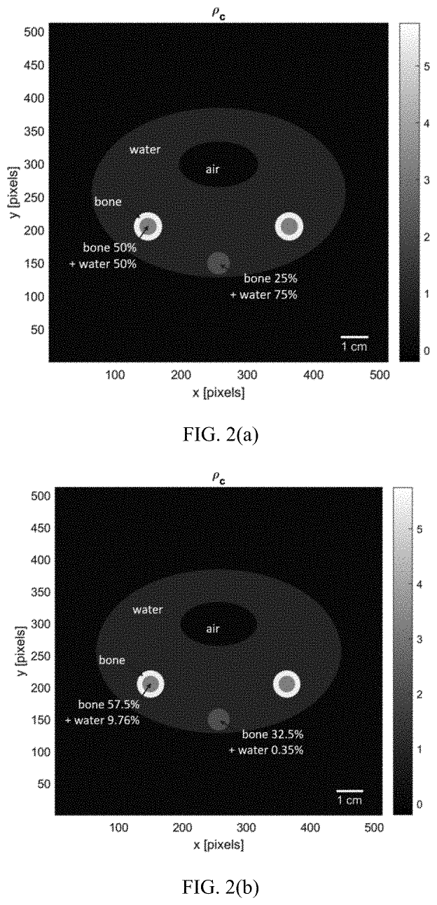

For test phantoms, elliptical object with various mixtures of water and cortical bone (ICRU-44) were used. Maximum thickness of the object was 9 cm, and maximum bone thickness along the rays was 1 cm. Two variations were considered: Phantom 1 and Phantom 2. Both phantoms were designed to produce the same ρ_{c} values, but with different fractions of bone and water for part bone-part water voxels. The bone-water fractions of Phantom 1 followed the volume conservation assumption exactly, while the fractions in Phantom 2 deviated from the volume conservation assumptions. Details of the numerical test phantoms are summarized in FIG. 2(a) and FIG. 2(b). The percentages shown in the diagrams of FIG. 2(a) and FIG. 2(b) indicate fractions of bone and water in each region in terms of volume. All materials are assumed to be mixtures of only bone and water.

For the simulation of sinograms, energy was discretized with 1 keV step-size from 5 keV to 50 keV. Poisson noise was applied to each discrete energy bin before energy-integration. To estimate F(T_{w}, T_{b}), a 33×33 grid was used to cover the range 0≤T_{w}≤16, 0≤T_{b}≤4. Then, for any pair (T_{w},T_{b}), the corresponding value of F was computed from the discrete data using bi-linear interpolation. It is assumed that the attenuation coefficients of water-like and bone-like materials in the calibration phantom are exactly the same as those of water and cortical bone, respectively.

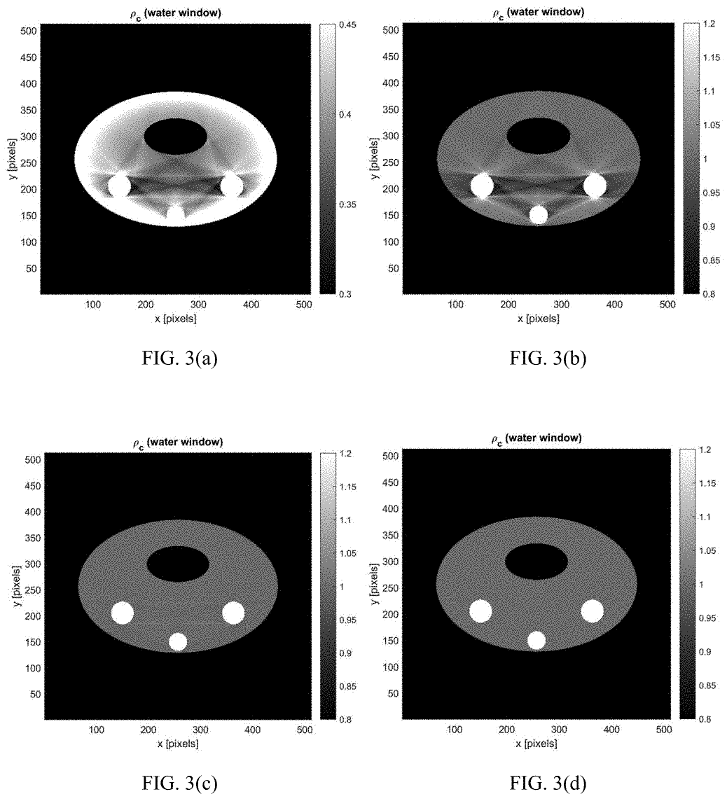

To present the performance of the proposed method, the reconstructed complete images ρ_{c} were compared. FIG. 3(a)-FIG. 3(d) show the reconstruction results of ρ_{c} for Phantom 1 with noiseless data using a compressed gray scale, wherein FIG. 3(a) shows the results with uncorrected data, FIG. 3(b) with the proposed method—after the 1^{st} iteration (water correction), FIG. 3(c) after the 2^{nd} iteration, and FIG. 3(d) after the 3^{rd} iteration. The images are shown in a compressed gray scale centered at the water level. The uncorrected reconstruction, FIG. 3(a) is shown here for comparison purposes and it is not part of the proposed algorithm. Note that the uncorrected CT image has different units from those of the others.

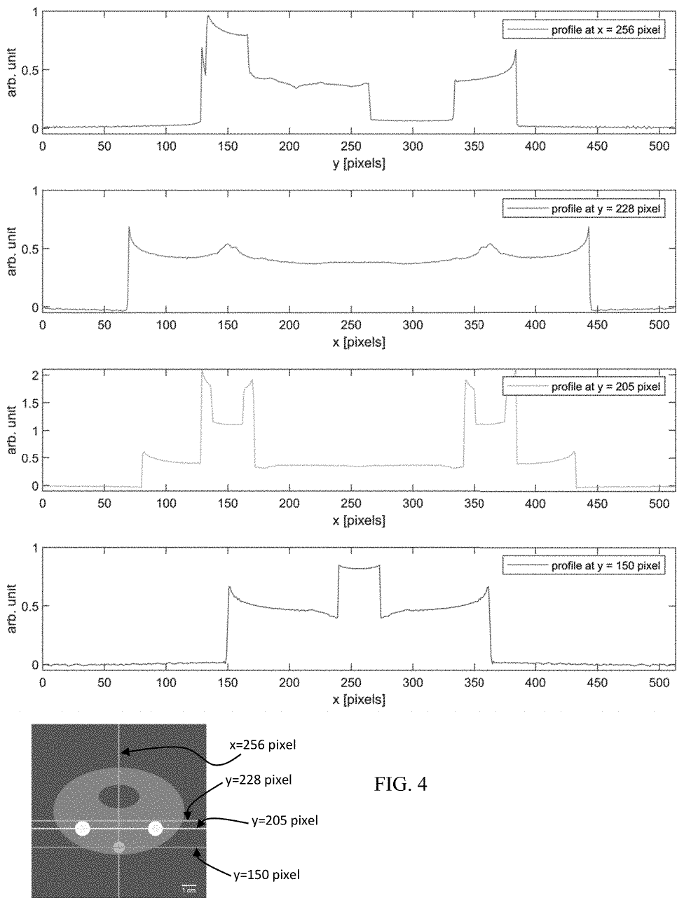

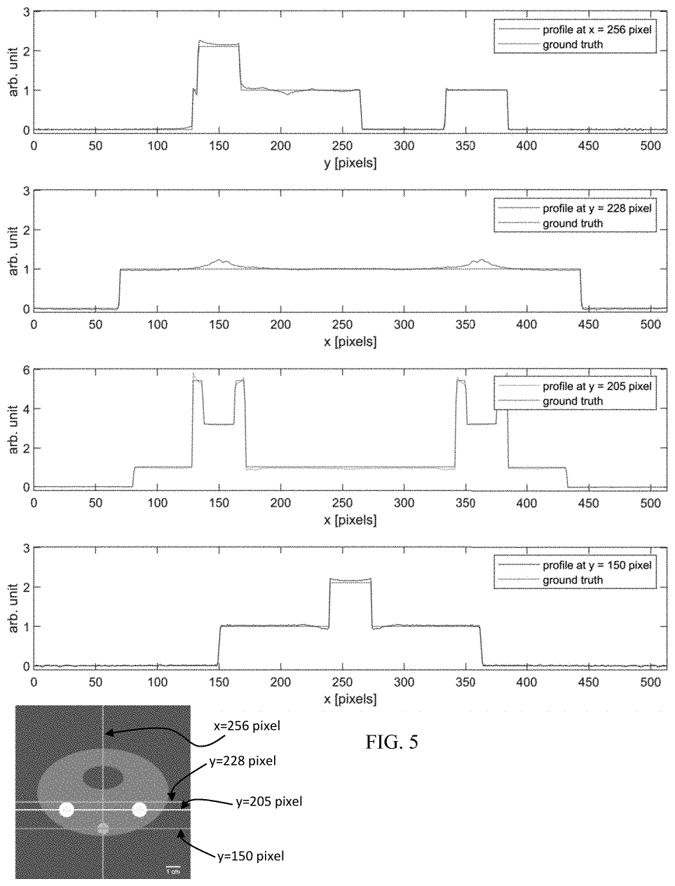

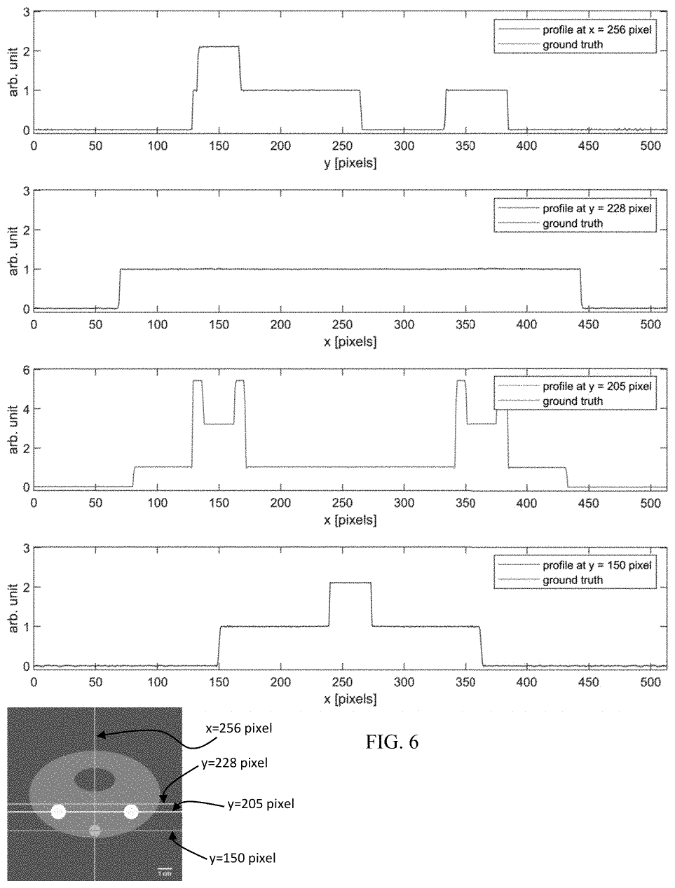

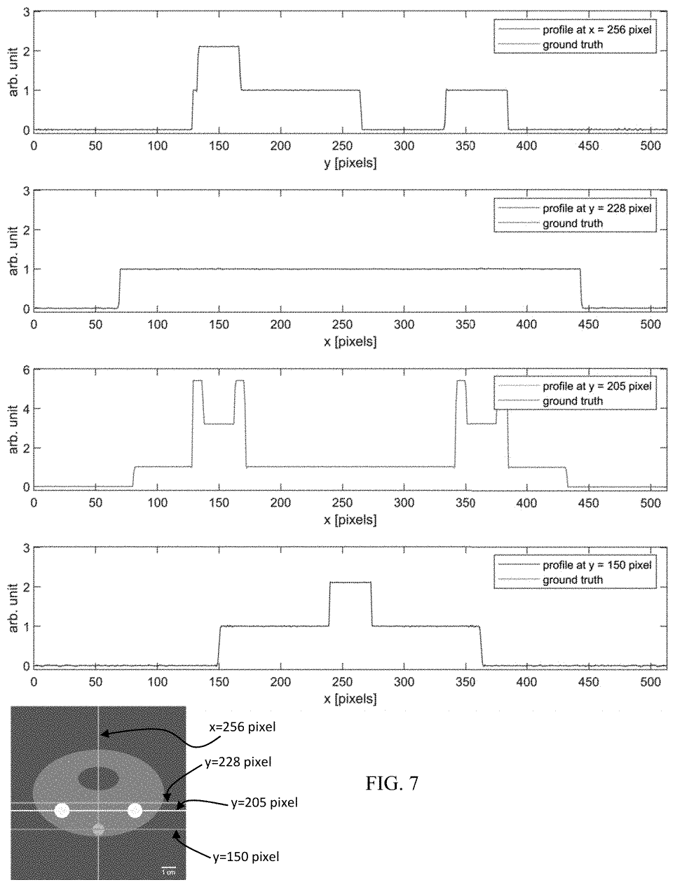

FIG. 4-FIG. 7 show the profiles of the reconstructed images ρ_{c} of Phantom 1 with noiseless data, from uncorrected data and after the 1^{st} (water correction), 2^{nd}, and 3^{rd} iterations of the proposed method, respectively. One can see that the beam hardening artifacts are almost completely removed after three iterations.

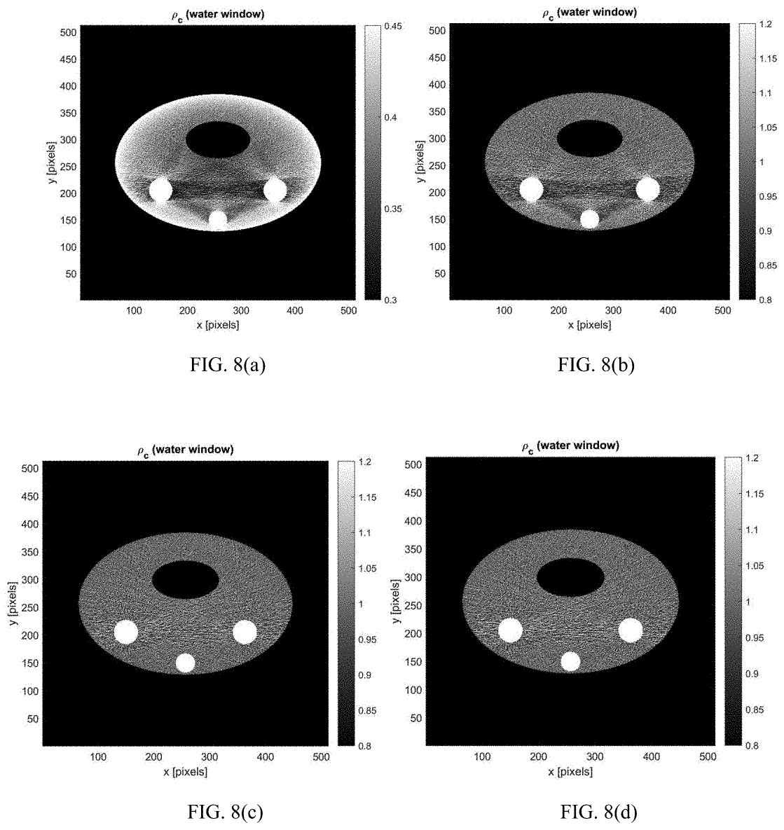

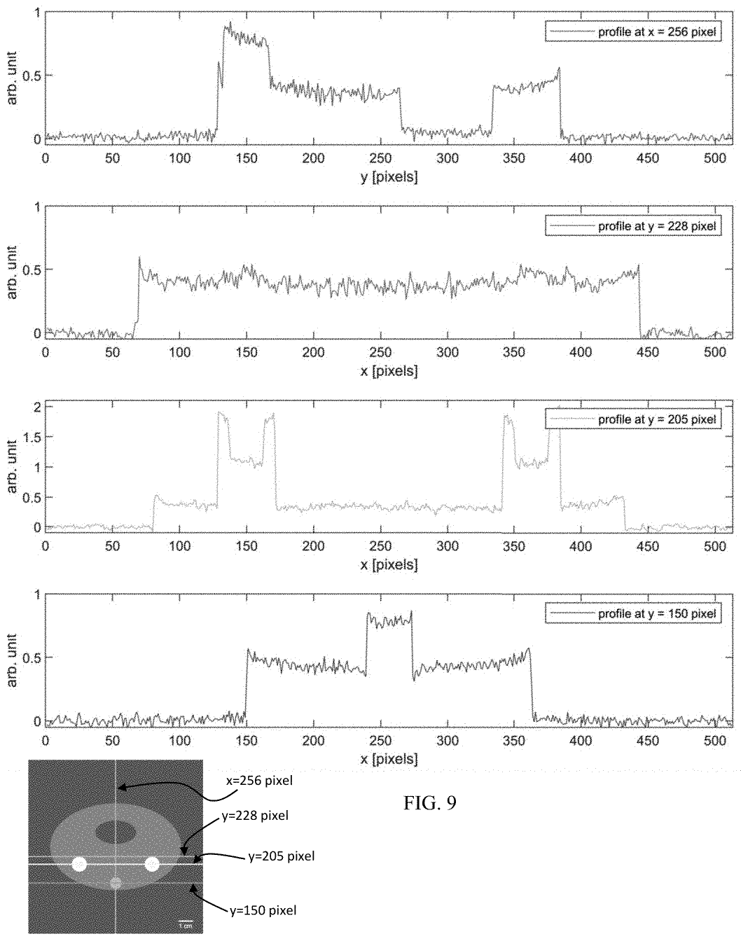

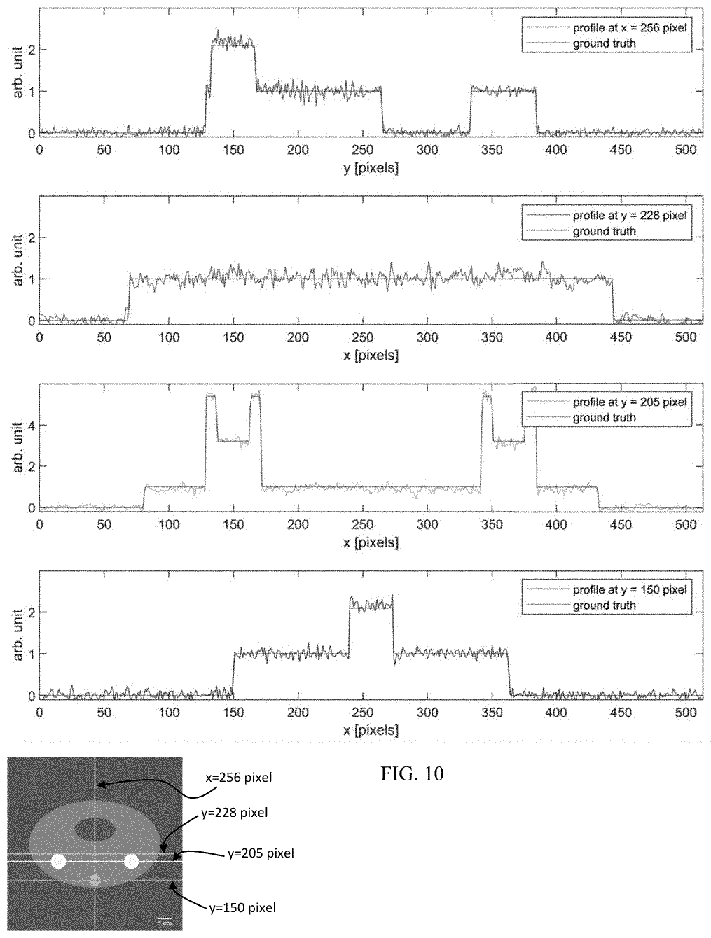

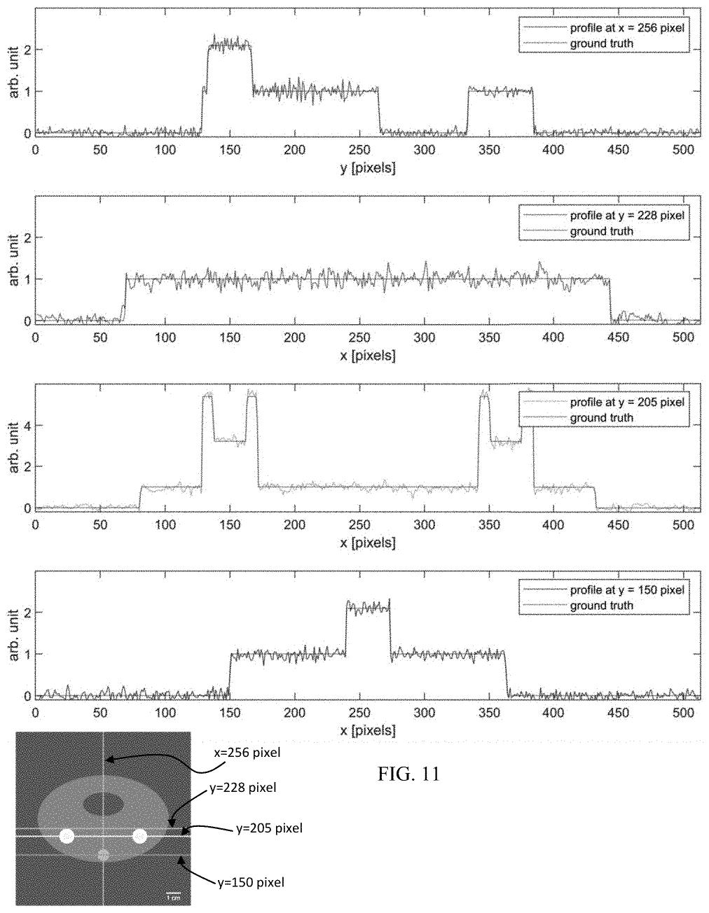

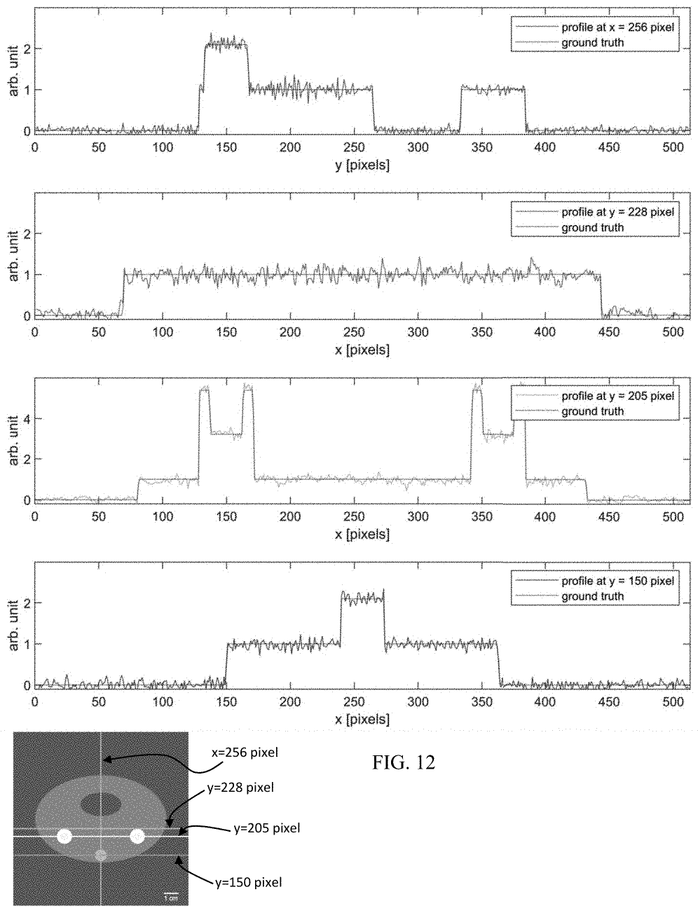

FIG. 8-FIG. 12 are the counterparts of FIG. 3-FIG. 7, with synthetic Poisson noise applied to the sinogram data. Parameters for the Poisson noise are computed based on the scanning system settings previously specified. One can see that the proposed method works well in the presence of a moderate amount of noise.

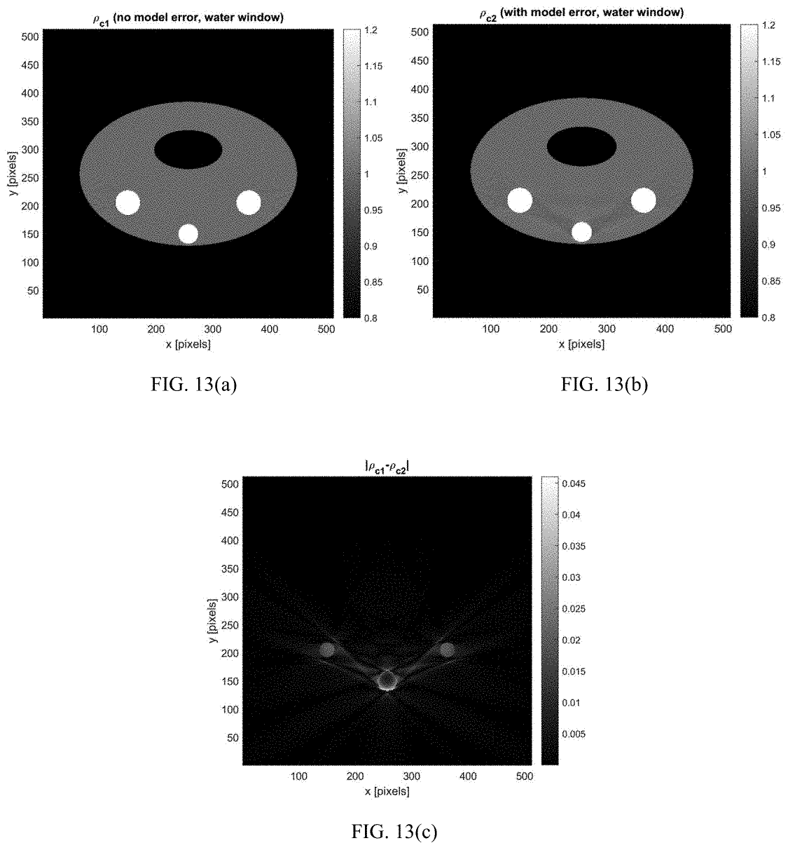

FIG. 13(a)-FIG. 13(c) show the comparison between reconstruction results of Phantom 1 shown in FIG. 13(a), where there is no segmentation model error, and Phantom 2 shown in FIG. 13(b), where there is segmentation model error, and their corresponding absolute difference between reconstruction results is shown in FIG. 13(c). In this embodiment, the data are noise free. Note that the deviations of bone fractions in Phantom 2 from the segmentation model curve are 15% and 30% for the regions where the bone fractions are 50% and 25% in Phantom 1, respectively.

As can be seen from the results shown in the various figures, the proposed method of the present invention corrects the beam hardening artifact with high accuracy, and the method is stable when data are contaminated by a moderate amount of noise. The model error in the soft-thresholding segmentation causes some beam hardening correction error for part bone-part water voxels. The proposed method is not applicable to identify the exact fractions of bone and water if the actual mixture does not follow the volume conservation assumption. However, the reconstruction error of the complete image ρ_{c} due to the model error is very low, with 2% to 3% of the true value. Compared to other potential sources of errors for the given scanner setting, e.g. noise or inaccurate estimation of F(T_{w},T_{b}), this model error appears to be insignificant.

The actual performance depends, essentially, on the accuracy of estimation of F(T_{w},T_{b}) in a physical experiment. Therefore, one must design a calibration phantom and a method to align it to get F(T_{w},T_{b}) correctly, which depends on the parameters of the specific scanner and the range of object properties to be scanned. It is noted that, in the present exemplary embodiment, a 33×33 grid of calibration data points was used to estimate F(T_{w},T_{b}) and bilinear interpolation was applied. However, the function F(T_{w},T_{b}), is smooth, so it may be possible to estimate the function with sufficient accuracy using low degree polynomials to reduce the required number of data points.

The present invention may be embodied on various computing platforms that perform actions responsive to software-based instructions. For example, the instructions for performing the BHC iterative image reconstruction algorithm may be stored on a computer readable storage medium and a processor of a computing device may be configured to execute the instructions to perform the method for BHC iterative image reconstruction as described. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, The present invention may be embodied on various computing platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A method for beam hardening correction (BHC) in image reconstruction from polyenergetic x-ray projection data, the method comprising:
acquiring polyenergetic x-ray calibration data from a calibration phantom having a known geometry and comprising at least two materials, wherein the at least two materials further comprises a first material and a second material and wherein the first material is different than the second material;
acquiring polyenergetic x-ray projection data of an object of interest; and
performing beam hardening correction (BHC) and reconstructing a 3D image of the object from the polyenergetic x-ray projection data and the polyenergetic x-ray calibration data using an iterative BHC in image reconstruction algorithm, wherein the iterative image reconstruction algorithm comprises at least two applications of a non-iterative reconstruction step.

2. The method of claim 1, wherein the non-iterative reconstruction step comprises a filtered-backprojection reconstruction algorithm.

3. The method of claim 1, further comprising selecting a calibration constant for the iterative BHC in image reconstruction algorithm that ensures faster convergence of the iterative BHC in image reconstruction algorithm, wherein the calibration constant is reflective of a ratio of attenuations of the first material and the second material comprising the calibration phantom.

4. The method of claim 1, wherein the iterative BHC in image reconstruction algorithm further comprises performing segmentation of images derived from images reconstructed at the non-iterative reconstruction step to generate a segmented second material image.

5. The method of claim 4, further comprising forward projecting of image derived from the segmented second material image to generate projection data.

6. The method of claim 5, further comprising linearizing the projection data with respect to the first material for at least one x-ray beam, given an optical thickness of the second material for the at least one x-ray beam.

7. The method of claim 1, further comprising:
performing a scan of the object of interest by a scanner operating under one or more spectral conditions to acquire the polyenergetic x-ray projection data of the object of interest; and
performing a scan of the calibration phantom by the scanner operating under the spectral conditions to acquire the polyenergetic x-ray calibration data of the calibration phantom, wherein the spectral conditions of the scanner used to acquire the polyenergetic x-ray projection data of the object of interest are the same as the spectral conditions of the scanner used to acquire the polyenergetic x-ray calibration data of the calibration phantom.

8. The method of claim 7, wherein the spectral conditions include an x-ray source spectrum and filtration material and thickness.

9. The method of claim 7, wherein performing the scan of the calibration phantom is performed prior to performing the scan of the object of interest or subsequent to performing the scan of the object of interest.

10. The method of claim 1, wherein the first material of the calibration phantom is a water-like material and the second material of the calibration phantom is a bone-like material.

11. The method of claim 1, wherein the iterative BHC in image reconstruction algorithm is theoretically exact.

12. A system for beam hardening correction (BHC) in image reconstruction from polyenergetic x-ray projection data, the system comprising:
a memory for storing polyenergetic x-ray calibration data acquired from a scan of a calibration phantom having a known geometry and comprising at least two materials and wherein the at least two materials further comprises a first material and a second material and wherein the first material is different than the second material, and for storing polyenergetic x-ray projection data acquired from a scan of an object of interest; and
a data processor for performing BHC in image reconstruction from the polyenergetic x-ray projection data and the polyenergetic x-ray calibration data, wherein the data processor is adapted for performing operations to apply an iterative BHC in image reconstruction algorithm that comprises at least two applications of a non-iterative reconstruction step.

13. The system of claim 12, wherein the first material is a water-like material and the second material is a bone-like material.

14. The system of claim 12, further comprising selecting a calibration constant for the iterative BHC in image reconstruction algorithm that ensures faster convergence of the iterative BHC in image reconstruction algorithm, wherein the calibration constant is reflective of a ratio of attenuations of the first material and the second material comprising the calibration phantom.

15. The system of claim 12, wherein the iterative BHC in image reconstruction algorithm further comprises performing segmentation of images derived from images reconstructed at the non-iterative reconstruction step to generate a segmented second material image.

16. The method of claim 15, further comprising forward projecting of image derived from the segmented second material image to generate projection data.

17. The method of claim 16, further comprising linearizing the projection data with respect to the first material for at least one x-ray beam, given an optical thickness of the second material for the at least one x-ray beam.

18. One or more non-transitory computer-readable media having computer-executable instructions for performing a method of running a software program on a computing device for performing beam hardening correction (BHC) in image reconstruction from polyenergetic x-ray projection data, the computing device operating under an operating system, the method including issuing instructions from the software program comprising:
acquiring polyenergetic x-ray calibration data from a calibration phantom having a known geometry and comprising at least two materials, wherein the at least two materials further comprises a first material and a second material and wherein the first material is different than the second material;
acquiring polyenergetic x-ray projection data of an object of interest; and
performing beam hardening correction (BHC) and reconstructing a 3D image of the object from the polyenergetic x-ray projection data and the polyenergetic x-ray calibration data using an iterative BHC in image reconstruction algorithm, wherein the iterative image reconstruction algorithm comprises at least two applications of a non-iterative reconstruction step.

19. The media of claim 18, further comprising selecting a calibration constant for the iterative BHC in image reconstruction algorithm that ensures faster convergence of the iterative BHC in image reconstruction algorithm, wherein the calibration constant is reflective of a ratio of attenuations of the first material and the second material comprising the calibration phantom.

20. The media of claim 18, wherein the iterative BHC in image reconstruction algorithm further comprises:
performing segmentation of images derived from images reconstructed at the non-iterative reconstruction step to generate a second material image;
forward projecting of image derived from the segmented second material image to generate projection data;
linearizing the projection data with respect to the first material for at least one x-ray beam, given an optical thickness of the second material for the at least one x-ray beam; and
applying the non-iterative image reconstruction algorithm to the linearized projection data.
